(19) United States
(12) Patent Application Publication
(10) Pub. No.: US 2026/0148435 A1
(43) Pub. Date: May 28, 2026

(54) VISUAL TREATMENT FOR USER FACE REPRESENTATION WHEN OCCLUDED

(71) Applicant: Apple Inc., Cupertino, CA (US)

(72) Inventor: Nathaniel Dirksen, Redwood City, CA (US)

(21) Appl. No.: 19/382,890

(22) Filed: Nov. 7, 2025

Related U.S. Application Data
(60) Provisional application No. 63/818,645, filed on Jun. 5, 2025.
(60) Provisional application No. 63/723,895, filed on Nov. 22, 2024.

(51) Int. Cl. G06T 11/00

(52) U.S. Cl. CPC G06T 11/00

(57) ABSTRACT

Various implementations disclosed herein include devices, systems, and methods that detect that a portion of a user’s face (e.g., the user’s mouth) is occluded or about to be occluded in sensor data and, accordingly, determine to use prior user data to generate at least a portion of a user representation during the time period during which the face portion is occluded.

### CROSS-REFERENCE TO RELATED APPLICATIONS

This Application claims the benefit of U.S. Provisional Application Serial No. 63/723,895 filed November 22, 2024 and U.S. Provisional Application Serial No. 63/818,645 filed June 5, 2025, each of which is incorporated herein by reference in their entirety.

### TECHNICAL FIELD

The present disclosure generally relates to electronic devices, and in particular, to systems, methods, and devices for representing the appearances of users based on images and other sensor data.

### BACKGROUND

Existing techniques may not adequately represent the appearances of users of electronic devices in various circumstances. For example, user representations may have undesirable appearance characteristics in circumstances in which the sensor data upon which the representations are based is incomplete, e.g., when a user’s hand, a pen, a cup, an item of food, etc. occludes the user’s mouth in image sensor data such that the actual appearance of the user’s mouth is not accurately represented in current image data.

### SUMMARY

Various implementations disclosed herein include devices, systems, and methods that detect that a portion of a user’s face (e.g., the user’s mouth) is occluded or about to be occluded in sensor data and, accordingly, determine to use prior user data to generate at least a portion of a user representation during the time period during which the face portion is occluded.

In general, one innovative aspect of the subject matter described in this specification can be embodied in a method performed by a processor executing instructions embodied in a non-transitory computer-readable medium. The method may involve determining a sensor data condition corresponding to a portion of a face of a user being occluded in sensor data, e.g., detecting that a portion of a user’s face (e.g., the user’s mouth) is obscured or about to be obscured in sensor data. The method may further involve, based on determining the sensor data condition, determining to utilize prior user data to generate at least a portion of a user representation corresponding to the portion of the face of the user being occluded in the sensor data during a period of time. The method may further involve generating the user representation corresponding to the portion of the face of the user being occluded in the sensor data during the period of time.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device obtaining sensor data from a user according to some implementations.

FIG. 2 illustrates exemplary electronic devices operating in different physical environments during a communication session in accordance with some implementations.

FIGS. 3A-C illustrate a portion of a user’s face becoming occluded in sensor data during exemplary instants in time during a period of time during which a representation of the user’s face is to be generated based on the sensor data, in accordance with some implementations.

FIGS. 4A-C illustrate the representation of the user’s face of FIGS. 3A-C generated for the instants in time during the period of time in accordance with some implementations.

FIG. 5 illustrates an exemplary visual treatment used to provide an indication that the user’s face depicted in a representation may not correspond to the current appearance of the user in accordance with some implementations.

FIGS. 6A-B illustrate a portion of a user’s face becoming un-occluded in sensor data during exemplary instants in time during a period of time during which a representation of the user’s face is to be generated based on the sensor data, in accordance with some implementations.

FIGS. 7A-B illustrate the representation of the user’s face of FIGS. 6A-B generated for the instants in time during the period of time in accordance with some implementations.

FIG. 8 is a flowchart representation of a method for generating at least a portion of a user representation during a time period during which a face portion is occluded, in accordance with some implementations.

FIG. 9 is a block diagram illustrating device components of an exemplary device according to some implementations.

FIG. 10 is a block diagram of an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

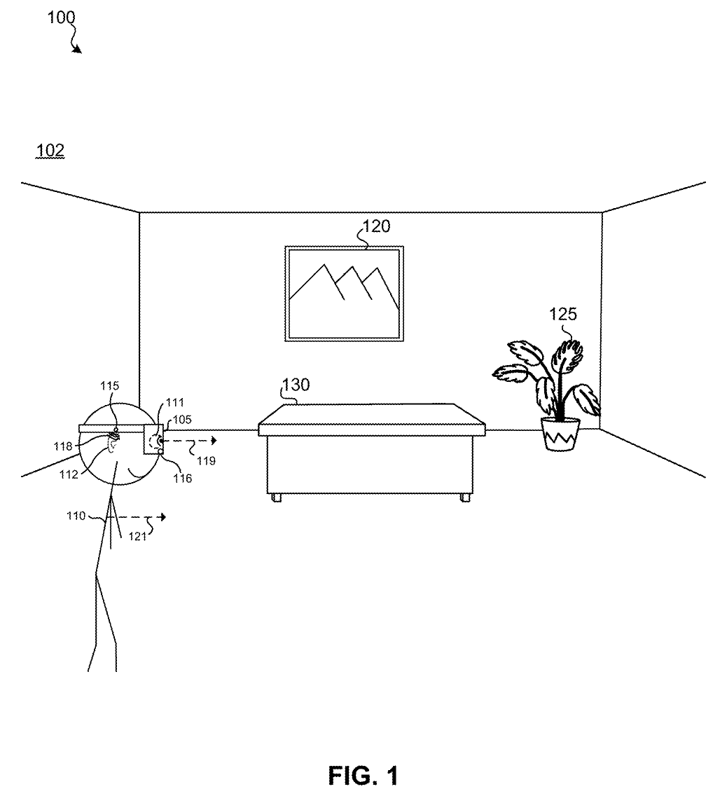

FIG. 1 illustrates an example environment 100 of exemplary electronic device 105, operating in a physical environment 102. In some implementations, electronic device 105 may be able to share information with another device or with an intermediary device, such as an information system. Additionally, physical environment 102 includes user 110 wearing device 105. In some implementations, the device 105 is configured to present views of an extended reality (XR) environment, which may be based on the physical environment 102, and/or include added content such as virtual elements.

In the example of FIG. 1, the physical environment 102 is a room that includes physical objects such as wall hanging 120, plant 125, and desk 130. The electronic device 105 may include one or more cameras, microphones, depth sensors, motion sensors, or other sensors that can be used to capture information about and evaluate the physical environment 102 and the objects within it, as well as information about user 110.

In the example of FIG. 1, the device 105 includes one or more sensors 116 that capture light-intensity images, depth sensor images, audio data or other information about the user 110 (e.g., internally facing sensors and/or externally facing cameras). For example, the one or more sensors 116 may capture images of the user’s (e.g., user 110) forehead, eyebrows, eyes, eye lids, cheeks, nose, lips, chin, face, head, hands, wrists, arms, shoulders, torso, legs, or other body portion. For example, internally facing sensors may see what’s inside of the device 105 (e.g., the user’s eyes and around the eye area), and other external cameras may capture the user’s face outside of the device 105 (e.g., egocentric cameras that point toward the user 110 outside of the device 105). Sensor data about a user’s eye 111, as one example, may be indicative of various user characteristics, e.g., the user’s gaze direction 119 over time, user saccadic behavior over time, user eye dilation behavior over time, etc. The one or more sensors 116 may capture audio information including the user’s speech and other user-made sounds as well as sounds within the physical environment 100.

In some implementations, the device 105 includes an eye tracking system for detecting eye position and eye movements via eye gaze characteristic data. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 110. Moreover, an illumination source of the device 105 may emit NIR light to illuminate the eyes of the user 110 and an NIR camera may capture images of the eyes of the user 110. In some implementations, images captured by the eye tracking system may be analyzed to detect position and movements of the eyes of the user 110, or to detect other information about the eyes such as color, shape, state (e.g., wide open, squinting, etc.), pupil dilation, or pupil diameter. Moreover, the point of gaze estimated from the eye tracking images may enable gaze-based interaction with content shown on the near-eye display of the device 105.

Additionally, the one or more sensors 116 may capture images of the physical environment 100 (e.g., externally facing sensors). For example, the one or more sensors 116 may capture images of the physical environment 100 that includes physical objects such as wall hanging 120, plant 125, and desk 130. Moreover, the one or more sensors 116 may capture images (e.g., light intensity images and/or depth data).

One or more sensors, such as one or more sensors 115 on device 105, may identify user information based on proximity or contact with a portion of the user 110. As example, the one or more sensors 115 may capture sensor data that may provide biological information relating to a user’s cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 110 is facing.

Some implementations disclosed herein determine a user understanding or a scene understanding based on sensor data obtained by a user worn device, such as first device 105. Such a user understanding may be indicative of a user state that is associated with providing user assistance or facilitating a communication session.

Content may be visible, e.g., displayed on a display of device 105, or audible, e.g., produced as audio 118 by a speaker of device 105. In the case of audio content, the audio 118 may be produced in a manner such that only user 110 is likely to hear the audio 118, e.g., via a speaker proximate the ear 112 of the user or at a volume below a threshold such that nearby persons are unlikely to hear. In some implementations, the audio mode (e.g., volume), is determined based on determining whether other persons are within a threshold distance or based on how close other persons are with respect to the user 110.

In some implementations, the content provided by the device 105 and sensor features of device 105 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

The device 105 may generate user face representations of user 110 based on image and/or other sensor data for various purposes. For example, the user 110 may use the device 105 (e.g., a head-mounted device (HMD)) that has image sensors that capture images of the user’s face portions (e.g., images of the user’s eyes via cameras inside the HMD and/or images of the user’s cheeks, nose, and mouth via downward-facing cameras on the HMD). A stream of image and/or other sensor data may be obtained over time and used to animate a user face representation, e.g., providing a user avatar that represents the user’s face as the user forms facial expressions and otherwise moves their face over time.

A user face representation may combine live and prior data about the user. For example, live sensor data representing the current appearance of the portions of the user’s face (e.g., images of the user’s eyes via cameras inside the HMD and/or images of the user’s cheeks, nose, and mouth via downward-facing cameras on the HMD) may be combined with prior data representing the face at one or more prior times (e.g., enrollment data representing the face without the HMD on in one or more expressions, e.g., neutral expressions, smiling expressions, etc.).

User face representation data may be 3D or otherwise use information about the 3D appearance of the user’s face. In some implementations, current sensor data corresponding to the users’ current/live face appearance (e.g., current images from inward and downward facing sensors) is combined with information about the 3D shape of the user’s face to provide the user face representation. A user’s face representation may be used for numerous purposes including, but not limited to, to provide a representation of the user that is provided to one or more other users during a communication session.

Implementations disclosed herein account for circumstances during a time during which a user’s face representation is being captured when the sensors recording portions of the user’s face (e.g., sensors 116) are occluded, e.g., when cameras recording the mouth of the user 110 (e.g., downward facing cameras on an HMD) are obscured by the user’s hand during a FaceTime® call). The device (e.g., HMD) may be unable to accurately determine the facial expression in this case and may performs one or more processes to account for this lack of information. For example, the device 105 (e.g., HMD) may identify content to display during that period during which the portion of the user’s face is obscured. For example, it may use information from one or more prior instants in time in which the face was not occluded (e.g., the camera images available from the point in time immediately prior to the portion of the face being occluded and/or camera images available from an enrollment that represent the face in a particular (e.g., neutral) configuration).

Some implementations utilize information from a prior user enrollment. During such an enrollment, the system (e.g., HMD) may have captured images or other sensor data corresponding to the user’s face in one or more particular (e.g., smiling, frowning, neutral, mouth-closed, expressionless, etc.) configurations. Such information may be used for later periods during which a user representation requires current user sensor data but some (or all) of that sensor data is unavailable due to a portion of the user’s face being occluded. Information during a live capture session may also be captured and preserved for use during such periods, e.g., by saving the camera or other sensor data from one or more instants in time prior to the current instant in time.

In some implementations, based on detecting that a portion of the user’s face (e.g., the user’s mouth) is occluded or about to be occluded in sensor data, the device 105 (e.g., HMD) or another device being used to display the representation determines to use prior user sensor data to generate a user representation during the period during which the face portion is or will be occluded. In some implementations, the user’s immediately previous expression is preserved, e.g., reusing the sensor data from the immediately prior time instant. For example, as soon as the user 110 does something that covers their mouth, the device 110 (e.g., HMD) may provide the user’s prior expression for the portion of the user’s face that is occluded, e.g., reverting the user’s current expression for the portion of the user’s face that is occluded to the user’s expression in an immediately prior time instant before the mouth was covered. Other portions of the user’s face (e.g., the user’s eyes, cheeks, etc.) may continue to be represented based on current sensor data. A treatment (e.g., feathering may be applied between a portion of the user’s face represented based on prior data and a portion of the user’s face represented based on current data). For example, a user’s prior mouth expression (based on the mouth being currently obscured) may be combined with current upper face sensor data which is still being tracked such that the user’s eyes and upper face in the representation continues to convey the user’s current face (e.g., live expression).

In some implementations this prior expression-based representation is gradually changed over time as the user’s face portion continues to be occluded. This may convey to an observer that the user’s face is not frozen/stuck in the prior position and/or avoid continuing to display a representation in an unnatural or otherwise undesirable frozen pose (e.g., appearing to be frozen with mouth wide open, etc.). In some examples, this involves gradually (e.g., over a period of time) morphing or fading the appearance of the obscured portion of the user’s face to a different expression, e.g., to a neutral/expressionless or other predetermined expression). For example, the user’s face may initially be displayed in its prior pose and then gradually be morphed/faded back to a neutral mouth expression using enrollment data. This may help ensure that if the user is doing something unusual with their mouth, the user is not just stuck with that unusual (e.g., funny/frozen-looking) mouth expression. It may remain neutral as long as the mouth is covered.

Once the portion of the user’s face is no longer occluded, the device 105 (e.g., HMD) may blend from the predetermined (e.g., neutral) expression back to the live animated view, e.g., using live sensor data of the previously obscured portion of the user’s face. In alternative implementations, once the portion of the user’s face is no longer occluded, e.g., in the case of a short-lived occlusion, the device 105 blends from the prior-expression-based representation (or from the current blend of prior-expression and predetermined expression) back to the live animated view.

In some implementations, one or more visual treatments are applied during the period of time during which a portion of a user’s face is not based on live, current sensor data, e.g., during the time during which the portion of the face is occluded. Such treatment may blur, add (e.g., adding a light blue glow), or otherwise modify the appearance of the area of the portion of the face to hide artifacts that may occur based on using a combination of live and prior sensor data. Additionally (or alternatively), such visual treatments may convey to an observer that what the observer is seeing may not be the user’s actual mouth, e.g., that it may not depict the user’s actual current facial expression. The visual effect may convey uncertainty or another measure of inaccuracy. The amount or other attributes of the visual effect may depend upon the amount of the user’s face that is obscured, e.g. increasing the amount and/or size of blur and/or glow effect based on the amount of the user’s face that is obscured.

In some implementations, the device 105 (e.g., HMD) is configured to predict that a portion of the user’s face is about to be (but not yet) blocked, e.g., based on detecting that the user’s hand is headed towards the user’s face. A visual treatment may be applied based on the prediction. In some implementations, during a period before an occlusion, when the device 105 determines that a future occlusion is likely, the user's face as depicted may still match their actual appearance. However, an added visual treatment blur/light/etc. may be applied to give the observer additional context as to what has happened once the occlusion occurs, by tying the appearance of the effect and its strength to the proximity of the hand to the mouth. This may be particularly useful since the occluding object (e.g., hand) may not be shown directly against the mouth, e.g., where the hand is not tracked/depicted when at close range to the head/device. In some implementations, an added visual treatment blur/light/etc. may be applied to reduce the amount of change that occurs once the mouth is occluded, since it can be partially applied. In these cases, with occlusion-based prediction (e.g., hand-based prediction), the device 105 may determine to not apply a visual effect to the face portion (e.g., to the mouth), but rather restrict it the torso, so as to tie it the effect to the hand, and not obscure the mouth.

In some implementations, the device 105 predicts that a hand is likely to occlude the mouth based on its path of motion. The device 105 may only display a representation of the hand when hand tracking is available, which may not be available when the hand is within a threshold distance of the device/head. However, based on predicting that the hand is likely to occlude the mouth, the device 105 may determine to show the hand for slightly longer than it would otherwise, using predicted motion of the hand to provide display of the hand once tracking is lost. This may further emphasize the connection between the hand covering the mouth, and the visual treatment, which might be less clear otherwise.

In some implementations, one or more heuristics are used when determining when to no longer treat the mouth as occluded, e.g., requiring the system to observe a certain number of non-occluded frames or a predetermined length of time before the device 105 begins removing the treatment.

In some implementations, a representation of a user’s face includes or is otherwise based on Gaussian splats, e.g., via a Gaussian spat-based 3D representation. In such implementations, facial expression blending over time may account for the splat-based representation. Blending based on splats may look very realistic and thus undesirably convey to an observer that the user’s face has an expression that is not the user’s real, current expression. Accordingly, visual treatments or other processes may be performed to intentionally convey that a user’s face may have a different expression. For example, rather than smoothly blending between a user’s previous facial expression to a predetermined/neutral expression, the transition may be intentionally speckled, modified with a classic-film dissolve effect, in a way that feels “smooth” but not like a natural human motion. For example, a film cross-dissolve effect is smooth, but an external viewer can easily tell it’s an artificial transition effect, rather than the user actual closing their mouth.

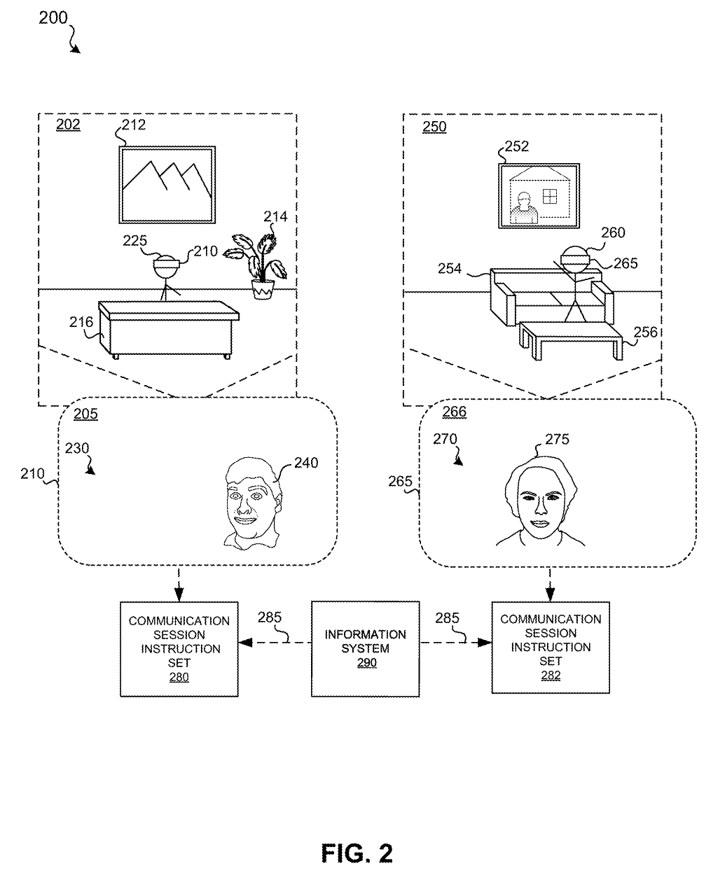

FIG. 2 illustrates exemplary electronic devices operating in different physical environments during a communication session of a first user at a first device and a second user at a second device with a view of a 3D representation of the second user for the first device in accordance with some implementations. In particular, FIG. 2 illustrates exemplary operating environment 200 of electronic devices 210, 265 operating in different physical environments 202, 250, respectively, during a communication session, e.g., while the electronic devices 210, 265 are sharing information with one another or an intermediary device such as a communication session system/server. In this example of FIG. 2, the physical environment 202 is a room that includes a wall hanging 212, a plant 214, and a desk 216 (e.g., physical environment 102 of FIG. 1). The electronic device 210 includes one or more cameras, microphones, depth sensors, or other sensors that can be used to capture information about and evaluate the physical environment 202 and the objects within it, as well as information about the user 225 of the electronic device 210 (e.g., a handheld device). The information about the physical environment 202 and/or user 225 may be used to provide visual content (e.g., for user representations) and audio content (e.g., for audible voice or text transcription) during the communication session. For example, a communication session may provide views to one or more participants (e.g., users 225, 260) of a 3D environment that is generated based on camera images and/or depth camera images of the physical environment 202, a representation of user 225.

Additionally, in this example of FIG. 2, the physical environment 250 is a room that includes a wall hanging 252, a sofa 254, and a coffee table 256. The electronic device 265 includes one or more cameras, microphones, depth sensors, or other sensors that can be used to capture information about and evaluate the physical environment 250 and the objects within it, as well as information about the user 260 of the electronic device 265 (e.g., a user worn device or HMD device, such as device 105). The information about the physical environment 250 and/or user 260 may be used to provide visual and audio content during the communication session. For example, a communication session may provide views of a 3D environment that is generated based on camera images and/or depth camera images (from electronic device 265) of the physical environment 250 as well as a representation of user 260 based on camera images and/or depth camera images (from electronic device 265) of the user 260. For example, a 3D environment may be sent by the device 210 by a communication session instruction set 280 in communication with the device 265 by a communication session instruction set 282 (e.g., via the information system 290 via network connection 285).

The information system 290 may orchestrate the sharing of assets (e.g., data associated with user representations 240, 275) between two or more devices (e.g., electronic devices 210 and 265).

FIG. 2 illustrates an example of a view 205 provided at device 210 including a user representation 240 (e.g., a persona of at least a portion of user 260), provided there is a consent to view the users’ representations of each user during a particular communication session. In particular, the user representation 240 of user 260 is generated based on one or more user representation techniques. The generation of user representations is further discussed herein.

FIG. 2 also illustrates a view 266 including a representation 275 (e.g., a persona) of at least a portion of the user 225 (e.g., from mid-torso up) within the 3D environment 270. The user representation 240 of user 260 may be generated at device 210 (e.g., the receiving/viewing device) by generating representations of the user 260 for the multiple instants in a period of time based on data obtained from device 265 (e.g., a frame-specific 3D representation of user 260). Alternatively, in some embodiments, user representation 240 of user 260 is generated at device 265 (e.g., the sending device) and sent to device 210 (e.g., receiving/viewing device to view a persona of the sender). In some embodiments, each of the representations 240 of user 260 and 275 of user 225 is generated by generating splats corresponding to user representation data.

In the example of FIG. 2, the electronic devices 210, 265 are illustrated as a head-mounted devices (HMDs). However, either of the electronic devices 210, 265 may be a mobile phone, a tablet, a laptop, or any other form of wearable device (e.g., head-worn device (glasses), headphones, an ear mounted device, and so forth). In some implementations, functions of each of the devices 210 and 265 are accomplished via two or more devices, for example a mobile device and base station or a head mounted device and an ear mounted device. Various capabilities may be distributed amongst multiple devices, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 210 and 265 may communicate with one another via wired or wireless communications. In some implementations, each device communicates with a separate controller or server to manage and coordinate an experience for the user (e.g., a communication session server). Such a controller or server may be located within or may be remote relative to the physical environment 202 and/or physical environment 250.

Additionally, in the example of FIG. 2, the 3D environments 230 and 270 may be based on a common coordinate system that can be shared with other users (e.g., providing a virtual room for personas for a multi-person communication session). In other words, a common coordinate system may be used for the 3D environments 230 and 270. A common reference point may be used to align the coordinate systems. In some implementations, the common reference point may be a virtual object within the 3D environment that each user can visualize within their respective views. For example, a common center piece table that the user representations (e.g., the user’s personas) are positioned around within the 3D environment. Alternatively, the common reference point is not visible within each view. For example, a common coordinate system of a 3D environment may use a common reference point for positioning each respective user representation (e.g., around a table/desk). Thus, if the common reference point is visible, then each view of the device would be able to visualize the “center” of the 3D environment for perspective when viewing other user representations. The visualization of the common reference point may become more relevant with a multi-user communication session such that each user’s view can add perspective to the location of each other user during the communication session.

In some implementations, the representations of each user may be realistic or unrealistic and/or may represent a current and/or prior appearance of a user. For example, a photorealistic representation of the user 225 or 260 may be generated based on a combination of live images and prior images of the user. The prior images may be used to generate portions of the representation for which live image data is not available (e.g., portions of a user’s face that are not in view of a camera or sensor of the electronic device 210 or 265 or that may be obscured by the respective device and/or occluded, for example, by a hand of the user). In one example, the electronic devices 210 and 265 are HMDs and live image data of the user’s face includes a downward facing camera that obtains images of the user’s cheeks and mouth and inward facing camera images of the user’s eyes, which may be combined with prior image data of the user’s other portions of the user’s face, head, and torso that cannot be currently observed from the sensors of the device. Prior data regarding a user’s appearance may be obtained at an earlier time during the communication session, during a prior use of the electronic device, during an enrollment process used to obtain sensor data of the user’s appearance from multiple perspectives and/or conditions, or otherwise.

In some implementations, generating one or more user representations for a communication session as illustrated in FIG. 2 (e.g., generating user representation 240, 275), may be based on one more rendering techniques, such as using a 3D mesh or a 3D point cloud. Alternatively, a 3D gaussian splat rendering approach may be used. Such an approach may use UV mapping and generate a proxy mesh representation.

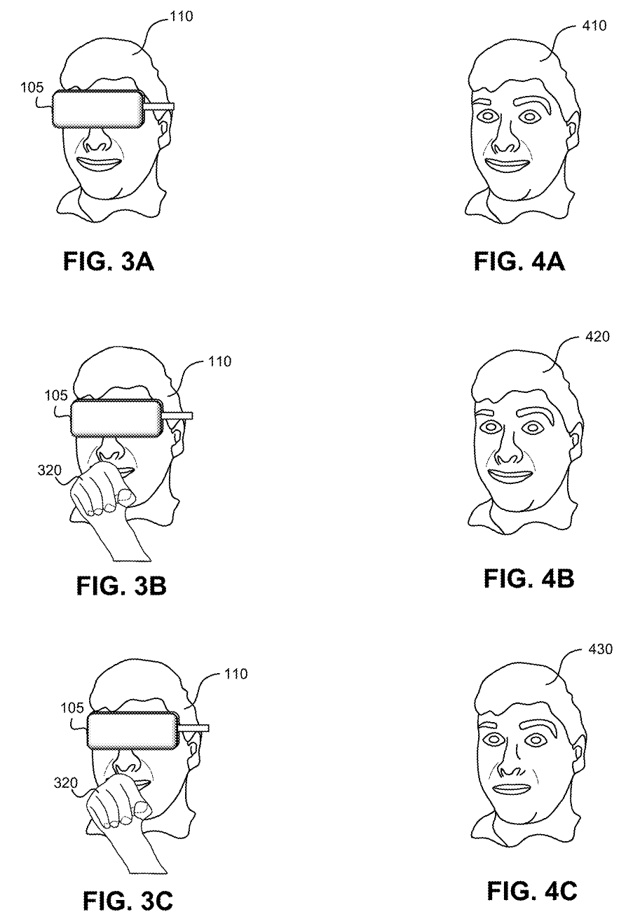

FIGS. 3A-C illustrate a portion of a user’s face becoming occluded in sensor data during exemplary instants in time during a period of time during which a representation of the user’s face is to be generated based on the sensor data. At a first instant in time (shown in FIG. 3A) the user is wearing device 105 but the rest of the user’s face is accessible to be captured via an unobstructed/un-occluded view from one or more sensors (e.g., via one or more outward/downward facing sensors on device 105). Following the first instant in time, at a second instant in time (shown in FIG. 3B), the user continues to wear device 105 and moves their hand 320 to a position that at least partially obstructs/occludes a view from one or more sensors (e.g., one or more outward/downward facing sensors on device 105 may have a limited view in which a portion of the user’s face (e.g., a mouth region) is not captured in the sensor data). Following the second instant in time, at a third instant in time (shown in FIG. 3C), the user continues to wear device 105 and continues to position their hand 320 at a position that at least partially obstructs/occludes a view from one or more sensors (e.g., one or more outward/downward facing sensors on device 105 may continue to have a limited view in which a portion of the user’s face (e.g., a mouth region) is not captured in the sensor data).

FIGS. 4A-C illustrate the representation of the user’s face of FIGS. 3A-C generated for the instants in time during the period of time. Specifically, for the first instant in time (illustrated in FIG. 3A), a user representation 410 (illustrated in FIG. 4A) is generated based on live sensor data capturing sensor data (e.g., captured via one or more outward/downward facing sensors on device 105) of the user’s face. The user representation 410 depicts a live/current appearance of the user’s face since the face is not occluded at this first instant in time. The user representation 410 may provide such an appearance using only live sensor data or a combination of live and previously captured sensor data (e.g., data form a prior user enrollment). Portions of the user’s face that are not occluded in live/current data are depicted in the user representation 410 to correspond to the user’s live/current appearance (e.g., if the user is currently smiling, user representation 410 will depict the user’s mouth region as smiling, etc.). In this example user representation 410, an eye region of the face is depicted based on a combination of current sensor data (e.g., internal facing cameras capturing the live/current condition of the user’s eye region) and prior enrollment data (e.g., information such as color about the appearance of the user’s eyes captured in sensor data when the device was not being worn by the user).

For the second instant in time (illustrated in FIG. 3B), a user representation 420 (illustrated in FIG. 4B) may be generated based on live sensor data capturing sensor data (e.g., captured via one or more outward/downward facing sensors on device 105) of the user’s face and/or previously captured sensor data (e.g., captured via one or more outward/downward facing sensors on device 105 at the first instant in time and/or during a prior enrollment process during which device 105 was not worn by the user). The user representation 420 depicts a non-live/non-current appearance of at least a portion of the user’s face since such portion of the face is occluded at this second instant in time. Specifically, in this example user representation 420, the mouth region of the face is depicted based on sensor data captured at the first instant in time when the mouth region was not occluded, e.g., the mouth region may maintain its appearance from the prior first period of time. In this example user representation 420, an eye region of the face is depicted based on a combination of current sensor data (e.g., internal facing cameras capturing the live/current condition of the user’s eye region) and prior enrollment data (e.g., information such as color about the appearance of the user’s eyes captured in sensor data when the device was not being worn by the user). Thus, a user representation may combine information from a user enrollment (e.g., information about user eye color) with current information about the user’s face (e.g., information about the user’s current eye direction and state and information about portions of the user’s face that are not occluded) and/or prior information about the user’s face from a recent instant in time (e.g., information about a user’s lower face portion that is currently occluded in the sensor data but was not occluded at the prior, recent instant in time). In some circumstances, prior information about a user’s face is obtained during a prior event separate from a prior enrollment. For example, at least some of the prior information about the user’s face may be obtained during the same communication session as the current information about the user’s face. Such information about the user’s face may provide information about the appearance of the user’s face including, but not limited to, information about a recent time at which the user’s mouth was not occluded during a given communication session. Various blending processes or visual effects may be utilized between facial portions representing prior and current sensor data, e.g., to ensure a smooth, continuous, or otherwise desirable transition between such portions.

For the third instant in time (illustrated in FIG. 3C), a user representation 430 (illustrated in FIG. 4C) may be generated based on live sensor data capturing sensor data (e.g., captured via one or more outward/downward facing sensors on device 105) of the user’s face and/or previously captured sensor data (e.g., captured via one or more outward/downward facing sensors on device 105 at a prior instant in time and/or during a prior enrollment process during which device 105 was not worn by the user). The user representation 430 depicts a non-live/non-current appearance of at least a portion of the user’s face since such portion of the face continues to be occluded at this third instant in time. Specifically, in this example user representation 430, the mouth region of the face is depicted based on sensor data captured during an enrollment process during which the mouth region was not occluded. Such an enrollment may have occurred separately and/or at a time prior the current communication session. During such an enrollment, one or more facial configurations / expressions may be captured in sensor data and used to provide the appearance of the portion of the face that is occluded during live capture. In this example, a neutral facial expression is generated based on sensor data captured during such an enrollment for the portion of the face (e.g., the mouth region) that is occluded. In this example user representation 430, an eye region of the face is depicted based on a combination of current sensor data (e.g., internal facing cameras capturing the live/current condition of the user’s eye region) and prior enrollment data (e.g., information such as color about the appearance of the user’s eyes captured in sensor data when the device was not being worn by the user). Thus, a user representation may combine information from a user enrollment (e.g., information about user neutral mouth region appearance and eye color) with current information about the user’s face (e.g., information about the user’s current eye direction and state and information about portions of the user’s face that are not occluded). Various blending processes or visual effects may be utilized between facial portions representing prior/enrollment sensor data and facial portions represented based on current sensor data, e.g., to ensure a smooth, continuous, or otherwise desirable transition between such portions.

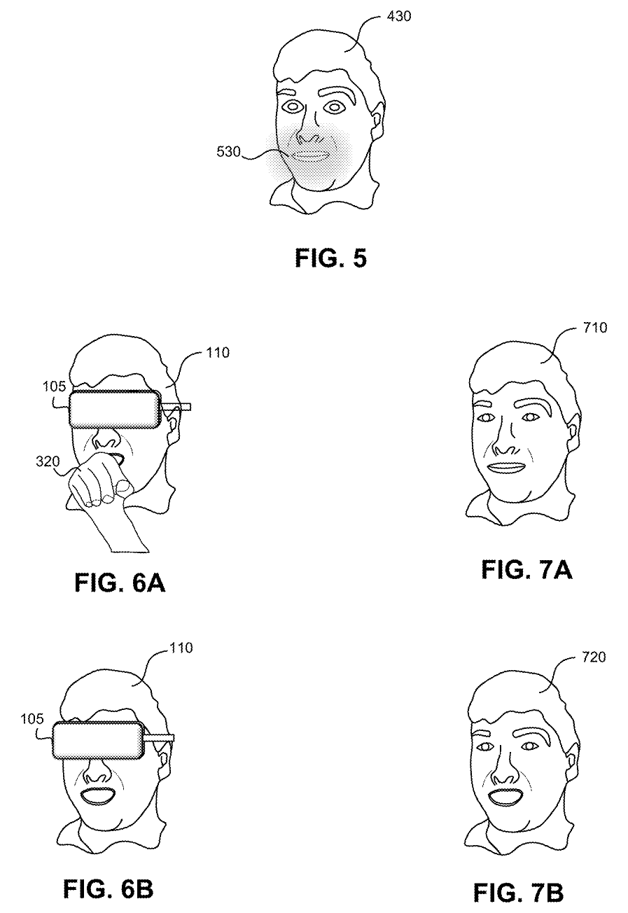

FIG. 5 illustrates an exemplary visual treatment used to provide an indication 530 that the user’s face depicted in a user representation 430 may not correspond to the current appearance of the user. For example, a user representation may be presented to second user during a live communication session. It may be desirable to provide an indication to the viewing second user that distinguished when the appearance of the user representation is not live/current. Such an indication may take various forms including, but not limited to, highlighting, coloring, blurring, outlining, dimming, or softening the region that does not correspond to the live/current user appearance.

Such indication may be useful for example in implementations in which the user representation (e.g., user representation 430) is generated using a Gaussian splatting technique (e.g., using points represented by parameters that include Gaussian distribution information representing the appearance of points on surface of the face to generate views from particular viewpoints, e.g., stereo viewpoints). Such techniques may provide user appearances that would otherwise be especially realistic and/or likely to be mistaken for the user’s live/current appearance or movements. It may be, for example, undesirable to give a realistic appearance that the user is smiling when the user is not actually smiling.

FIGS. 6A-B illustrate a portion of a user’s face becoming un-occluded in sensor data during exemplary instants in time during a period of time during which a representation of the user’s face is to be generated based on the sensor data. Following the third instant in time (FIG. 3C), at a fourth instant in time (shown in FIG. 6A) the user is wearing device 105 and continues to position their hand 320 at a position that at least partially obstructs/occludes a view from one or more sensors (e.g., one or more outward/downward facing sensors on device 105 may continue to have a limited view in which a portion of the user’s face (e.g., a mouth region) is not captured in the sensor data). Following the fourth instant in time (FIG. 6A), at a fifth instant in time (shown in FIG. 6B) the user is wearing device 105 and has moved their hand 320 away from their face such that a view from one or more sensors (e.g., one or more outward/downward facing sensors on device 105 is again able to capture sensor data corresponding to the portion of the user’s face (e.g., a mouth region) that was previously occluded in the sensor data).

FIGS. 7A-B illustrate the representation of the user’s face of FIGS. 6A-B generated for the instants in time during the period of time. For the fourth instant in time (illustrated in FIG. 6A), a user representation 710 (illustrated in FIG. 7A) may be generated based on live sensor data capturing sensor data (e.g., captured via one or more outward/downward facing sensors on device 105) of the user’s face and/or previously captured sensor data (e.g., captured via one or more outward/downward facing sensors on device 105 at a prior instant in time and/or during a prior enrollment process during which device 105 was not worn by the user). The user representation 710 depicts a non-live/non-current appearance of at least a portion of the user’s face since such portion of the face continues to be occluded at this fourth instant in time. Specifically, in this example user representation 710, even though the current appearance of the mouth (which is occluded by the hand 320) has an open mouth expression, the mouth region of the face continues to be depicted based on sensor data captured during an enrollment process during which the mouth region was not occluded (showing a closed mouth expression). During such an enrollment, one or more facial configurations / expressions may be captured in sensor data and used to provide the appearance of the portion of the face that is occluded during live capture. In this example, a neutral facial expression is generated based on sensor data captured during such an enrollment for the portion of the face (e.g., the mouth region) that is occluded. In this example user representation 710, an eye region of the face is depicted based on a combination of current sensor data (e.g., internal facing cameras capturing the live/current condition of the user’s eye region) and prior enrollment data (e.g., information such as color about the appearance of the user’s eyes captured in sensor data when the device was not being worn by the user). In this example of FIG. 7A, the eyes have partially-closed appearance based on the current partially-closed condition of the eyes at the fourth instant in time but have other characteristics, e.g., color, based on the prior enrollment of the user. A user representation may combine information from a user enrollment (e.g., information about user neutral mouth region appearance and eye color) with current information about the user’s face (e.g., information about the user’s current eye direction and state and information about portions of the user’s face that are not occluded). Various blending processes or visual effects may be utilized between facial portions representing prior/enrollment sensor data and facial portions represented based on current sensor data, e.g., to ensure a smooth, continuous, or otherwise desirable transition between such portions.

For the fifth instant in time (illustrated in FIG. 6B), a user representation 720 (illustrated in FIG. 7B) is generated based on live sensor data capturing sensor data (e.g., captured via one or more outward/downward facing sensors on device 105) of the user’s face. The user representation 720 depicts a live/current appearance of the user’s face since the face is no longer occluded at this fifth instant in time. The user representation 410 may provide such an appearance using only live sensor data or a combination of live and previously captured sensor data (e.g., data form a prior user enrollment). Portions of the user’s face that are not occluded in live/current data are depicted in the user representation 720 to correspond to the user’s live/current appearance (e.g., if the user is currently smiling, user representation 410 will depict the user’s mouth region as smiling, if the user’s eyes are partially-closed, the eyes will be partially closed, etc.). In this example user representation 410, an eye region of the face is depicted based on a combination of current sensor data (e.g., internal facing cameras capturing the live/current condition of the user’s eye region – partially-closed) and prior enrollment data (e.g., information such as color about the appearance of the user’s eyes captured in sensor data when the device was not being worn by the user).

A transition (e.g., over a period of time) may be applied to gradually change the appearance of the user’s face in the user representation 710 to the appearance of the user’s face in user representation 720. Such a gradual transition in face appearance from a non-live to a live appearance may provide a better viewing experience.

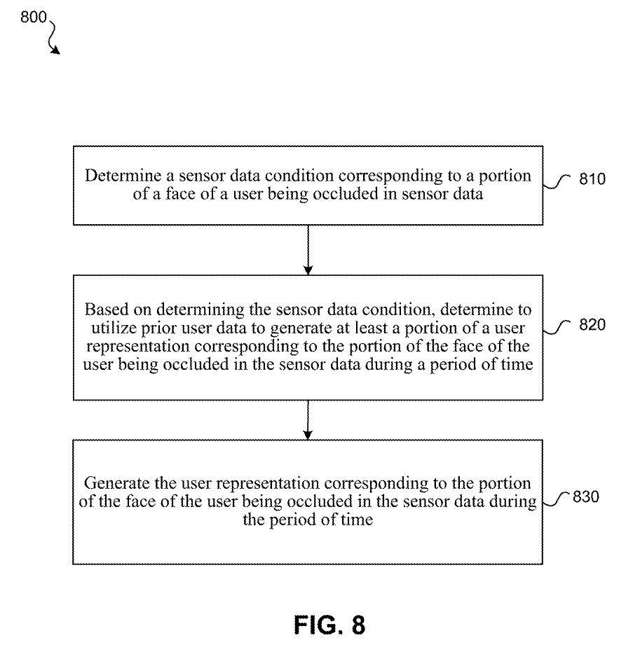

FIG. 8 is a flowchart illustrating an exemplary method 800. In some implementations, a device (e.g., device 105 of FIG. 1) performs the techniques of method 800 for generating at least a portion of a user representation during a time period during which a face portion is occluded. In some implementations, the techniques of method 800 are performed on a mobile device, desktop, laptop, HMD, or server device. In some implementations, the method 800 is performed on processing logic, including hardware, firmware, software, or a combination thereof. In some implementations, the method 800 is performed on a processor executing code stored in a non-transitory computer-readable medium (e.g., a memory). In some implementations, the method 800 is implemented at a processor of a device, such as a viewing device, that renders a representation of a user (e.g., device 210 of FIG. 2 renders 3D representation 240 of user 260 (a persona) from data obtained from device 265).

At block 810, the method 800 involves determining a sensor data condition corresponding to a portion of a face of a user being occluded in sensor dat. This may involve detecting that a portion of a user’s face (e.g., the user’s mouth) is occluded or about to be occluded in sensor data. It may involve determining that the portion of the face of the user is currently or is about to be occluded by a hand of the user. A hand of a user may be tracked, e.g., via one or more sensors on the device or another device. Movement of the hand over time may be used to predict that the hand will be in a position that prevents the sensors from obtaining sensor data regarding a face portion. Moreover, information about a user and/or the physical environment (such as a user’s prior hand motions, tendency to cover their mouth with their hand in certain circumstances, etc.) may be used to predict that the hand will be in a position that prevents the sensors from obtaining sensor data regarding the face portion.

At block 820, the method 800 involves, based on determining the sensor data condition, determining to utilize prior user data to generate at least a portion of a user representation corresponding to the portion of the face of the user being occluded in the sensor data during a period of time. As discussed with respect to FIGS. 3A-C, 4A-C, 6A-B, and FIGS. 7A-B, the prior user data may include user data representing an appearance of the portion of the face of the user captured during a time period immediately before occlusion occurs and/or user data representing an appearance of the portion of the face of the user captured during an enrollment period during which images of the face of the user are captured in a plurality of facial configurations (e.g., smiling, frowning, neutral, mouth-closed, expressionless, etc. configurations).

At block 830, the method 800 involves generating the user representation corresponding to the portion of the face of the user being occluded in the sensor data during the period of time. The user representation may be generated during a live capture session during which sensor data from period without occlusion is maintained for use during periods of occlusion. Generating the user representation corresponding to the portion of the face of the user being occluded in the sensor data may involve generating the user representation to preserve the immediately prior facial expression of the user during the period of time (e.g., using that last available/most current information available about the face portion).

Other portions of the face of the user may be represented based on live sensor data corresponding to the live appearance of the other portions of the face of the user during a period of time. A visual treatment is provided between the portion of the face of the user (based on prior data) and the other portions of the face of the user (based on current data). For example, feathering may be applied between a portion of the user’s face represented based on prior data and a portion of the user’s face represented based on current data).

Generating the user representation corresponding to the portion of the face of the user being occluded in the sensor data during the period of time may involve generating a gradual change for the portion of the face of the user being occluded in the sensor data, e.g., transitioning from a current appearance to a last observed appearance gradually and then gradually transitioning from that to an enrollment-based appearance. A gradual change may be applied to morph a first appearance of the portion of the face corresponding to a first expression occurring immediately prior to the occlusion to a second appearance of the portion of the face corresponding to a second expression different than the first expression (e.g., morph to neutral).

The method 800 may further involve determining a second sensor data condition corresponding to the portion of the face of the user no longer being occluded in the sensor data. For example, this may involve detecting that a portion of a user’s face (e.g., the user’s mouth) will no longer be obscured or about to be obscured in sensor data). The method 800 may further, based on determining the second sensor data condition, involve determining to utilize live user data to generate at least the portion of the user representation corresponding to the portion of the face of the user no longer being occluded in the sensor data during a second period of time, and generating the user representation corresponding to the portion of the face of the user no longer being occluded in the sensor data during the second period of time. Generating the user representation corresponding to the portion of the face of the user no longer being occluded in the sensor data during the second period of time may involve generating a gradual change for the portion of the face of the user. The gradual change may morphs a first appearance of the portion of the face corresponding to a first expression (e.g., an immediately prior or neutral expression) to a second appearance of the portion of the face corresponding to a second expression different than the first expression (e.g., to a live animated view). In some implementations, during a transition from the previous frame to the neutral frame is a three-way morph that blends between the previous/neutral frame (based on the progress through transition) to define the mouth region, and then between the mouth region and live frame across the face (so that the eyes stay alive, the mouth stays locked, and the area in between is smooth).

As illustrated in FIG. 5, the method 800 may involve applying a visual treatment while a user representation is based on non-live user data indicating that the portion of the face of the user represented in the user representation may not depict an actual current facial expression of the user. An attribute of the visual treatment may be based on an amount of the face that is occluded.

In some implementations, the user representation is generated based on generating Gaussian-based representations having 3D positions and then generating a view based on the Gaussian-based representations, wherein transitions between facial expressions are configured to convey unnatural changes. This may, for example, be performed in a way that feels “smooth,” but not like a natural human motion. For example, a film cross-dissolve effect is smooth, but an external viewer can easily tell it’s an artificial transition effect, rather than the user actual closing their mouth.

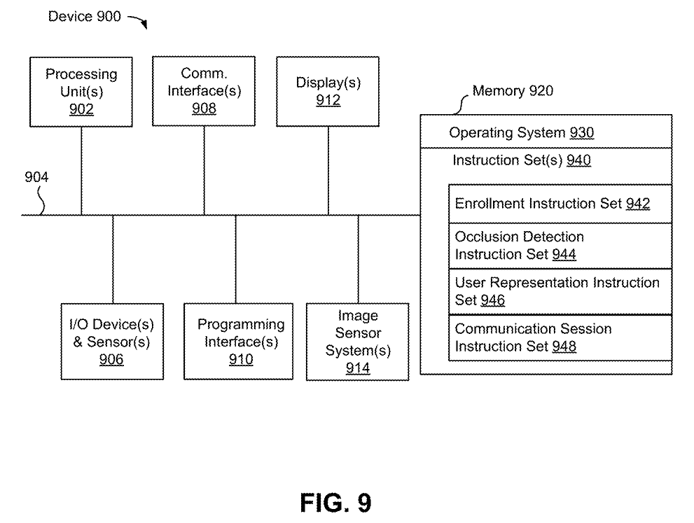

FIG. 9 is a block diagram of an example device 900. Device 900 illustrates an exemplary device configuration for devices described herein (e.g., devices 105, 210, 265, 410, etc.). While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 900 includes one or more processing units 902 (e.g., microprocessors, ASICs, FPGAs, GPUs, CPUs, processing cores, and/or the like), one or more input/output (I/O) devices and sensors 906, one or more communication interfaces 908 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 910, one or more displays 912, one or more interior and/or exterior facing image sensor systems 914, a memory 920, and one or more communication buses 904 for interconnecting these and various other components.

In some implementations, the one or more communication buses 904 include circuitry that interconnects and controls communications between system components. In some implementations, the one or more I/O devices and sensors 906 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 912 are configured to present a view of a physical environment or a graphical environment to the user. In some implementations, the one or more displays 912 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 912 correspond to diffractive, reflective, polarized, holographic, etc. waveguide displays. In one example, the device 10 includes a single display. In another example, the device 10 includes a display for each eye of the user.

In some implementations, the one or more image sensor systems 914 are configured to obtain image data that corresponds to at least a portion of the physical environment 102. For example, the one or more image sensor systems 914 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 914 further include illumination sources that emit light, such as a flash. In various implementations, the one or more image sensor systems 914 further include an on-camera image signal processor (ISP) configured to execute a plurality of processing operations on the image data.

The memory 920 includes high-speed random-access memory, such as DRAM, SRAM, DDR RAM, or other random-access solid-state memory devices. In some implementations, the memory 920 includes non-volatile memory, such as one or more magnetic disk storage devices, optical disk storage devices, flash memory devices, or other non-volatile solid-state storage devices. The memory 920 optionally includes one or more storage devices remotely located from the one or more processing units 902. The memory 920 includes a non-transitory computer readable storage medium.

In some implementations, the memory 920 or the non-transitory computer readable storage medium of the memory 920 stores an optional operating system 930 and one or more instruction set(s) 940. The operating system 930 includes procedures for handling various basic system services and for performing hardware dependent tasks. In some implementations, the instruction set(s) 940 include executable software defined by binary information stored in the form of electrical charge. In some implementations, the instruction set(s) 940 are software that is executable by the one or more processing units 902 to carry out one or more of the techniques described herein.

The instruction set(s) 940 include an enrollment instruction set 942, an occlusion detection instruction set 944, a user representation instruction set 946, and a communication session instruction set 948. The instruction set(s) 940 may be embodied a single software executable or multiple software executables.

In some implementations, the enrollment instruction set 942 is executable by the processing unit(s) 902 to generate enrollment data from image data. The enrollment instruction set 942 may be configured to provide instructions to the user in order to acquire image or other sensor information to generate the enrollment personification and determine whether additional image information is needed to generate an accurate enrollment personification to be used by the persona display process. To these ends, in various implementations, the instruction includes instructions and/or logic therefor, and heuristics and metadata therefor.

In some implementations, the occlusion detection instruction set 944 is executable by the processing unit(s) 902 to determine when an obstacle such as a hand of a user interferes or prevents a sensor from capturing a live/current appearance of a portion of a user, as described herein. The occlusion detection instruction set 944 may include or utilize an instruction set that performs body and/or hand tracking. To these ends, in various implementations, the instruction includes instructions and/or logic therefor, and heuristics and metadata therefor.

In some implementations, the user representation instruction set 946 is executable by the processing unit(s) 902 to generate a user representation using one or more of the techniques discussed herein or as otherwise may be appropriate. To these ends, in various implementations, the instruction includes instructions and/or logic therefor, and heuristics and metadata therefor.

In some implementations, the communication session instruction set 948 is executable by the processing unit(s) 902 to facilitate a communication session between two or more electronic devices (e.g., device 210 and device 265 as illustrated in FIG. 2) using one or more of the techniques discussed herein or as otherwise may be appropriate. To these ends, in various implementations, the instruction includes instructions and/or logic therefor, and heuristics and metadata therefor.

Although the instruction set(s) 940 are shown as residing on a single device, it should be understood that in other implementations, any combination of the elements may be located in separate computing devices. Moreover, FIG. 9 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

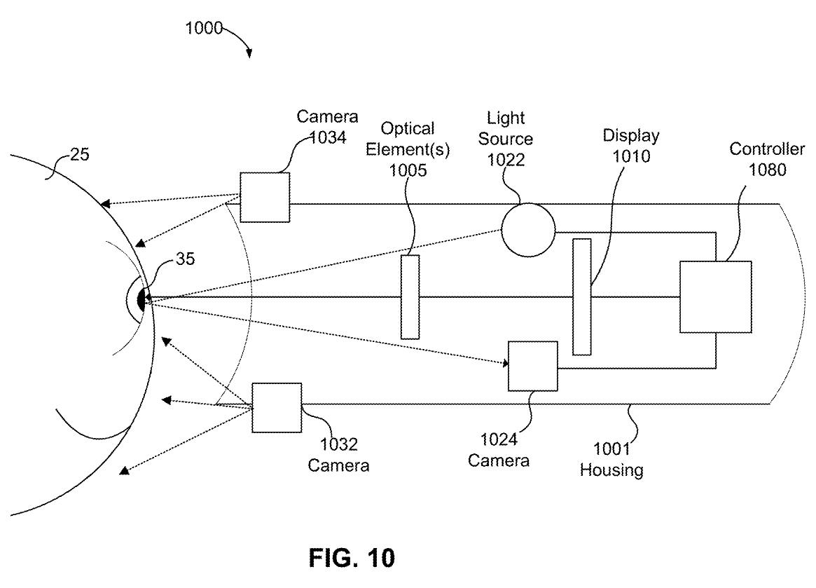

FIG. 10 illustrates a block diagram of an exemplary head-mounted device 1000 in accordance with some implementations. The head-mounted device 1000 includes a housing 1001 (or enclosure) that houses various components of the head-mounted device 1000. The housing 1001 includes (or is coupled to) an eye pad (not shown) disposed at a proximal (to the user 25) end of the housing 1001. In various implementations, the eye pad is a plastic or rubber piece that comfortably and snugly keeps the head-mounted device 1000 in the proper position on the face of the user 25 (e.g., surrounding the eye 35 of the user 25).

The housing 1001 houses a display 1010 that displays an image, emitting light towards or onto the eye of a user 25. In various implementations, the display 1010 emits the light through an eyepiece having one or more optical elements 1005 that refracts the light emitted by the display 1010, making the display appear to the user 25 to be at a virtual distance farther than the actual distance from the eye to the display 1010. For example, optical element(s) 1005 may include one or more lenses, a waveguide, other diffraction optical elements (DOE), and the like. For the user 25 to be able to focus on the display 1010, in various implementations, the virtual distance is at least greater than a minimum focal distance of the eye (e.g., 7 cm). Further, in order to provide a better user experience, in various implementations, the virtual distance is greater than 1 meter.

The housing 1001 also houses a tracking system including one or more light sources 1022, camera 1024, camera 1032, camera 1034, and a controller 1080. The one or more light sources 1022 emit light onto the eye of the user 25 that reflects as a light pattern (e.g., a circle of glints) that can be detected by the camera 1024. Based on the light pattern, the controller 1080 can determine an eye tracking characteristic of the user 25. For example, the controller 1080 can determine a gaze direction and/or a blinking state (eyes open or eyes closed) of the user 25. As another example, the controller 1080 can determine a pupil center, a pupil size, or a point of regard. Thus, in various implementations, the light is emitted by the one or more light sources 1022, reflects off the eye of the user 25, and is detected by the camera 1024. In various implementations, the light from the eye of the user 25 is reflected off a hot mirror or passed through an eyepiece before reaching the camera 1024.

The display 1010 emits light in a first wavelength range and the one or more light sources 1022 emit light in a second wavelength range. Similarly, the camera 1024 detects light in the second wavelength range. In various implementations, the first wavelength range is a visible wavelength range (e.g., a wavelength range within the visible spectrum of approximately 400–700 nm) and the second wavelength range is a near-infrared wavelength range (e.g., a wavelength range within the near-infrared spectrum of approximately 700–1400 nm).

In various implementations, eye tracking (or, in particular, a determined gaze direction) is used to enable user interaction (e.g., the user 25 selects an option on the display 1010 by looking at it), provide foveated rendering (e.g., present a higher resolution in an area of the display 1010 the user 25 is looking at and a lower resolution elsewhere on the display 1010), or correct distortions (e.g., for images to be provided on the display 1010). In various implementations, the one or more light sources 1022 emit light towards the eye 35 of the user 25 which reflects in the form of a plurality of glints.

In various implementations, the camera 1024 is a frame/shutter-based camera that, at a particular point in time or multiple points in time at a frame rate, generates an image of the eye 35 of the user 25. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user’s pupils.

In various implementations, the camera 1024 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1032 and camera 1034 are frame/shutter-based cameras that, at a particular point in time or multiple points in time at a frame rate, can generate an image of the face of the user 25. For example, camera 1032 captures images of the user’s face below the eyes, and camera 1034 captures images of the user’s face above the eyes. The images captured by camera 1032 and camera 1034 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user’s experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws.

It is to be understood that the implementations shown and described herein are only illustrative of the principles of the present invention and that various modification may be implemented by those skilled in the art without departing from the scope and spirit of the invention.

What is claimed is:

1. A method comprising:
at a processor of a head-mounted device (HMD):
determining a sensor data condition corresponding to a portion of a face of a user being occluded in sensor data;
based on determining the sensor data condition, determining to utilize prior user data to generate at least a portion of a user representation corresponding to the portion of the face of the user being occluded in the sensor data during a period of time; and
generating the user representation corresponding to the portion of the face of the user being occluded in the sensor data during the period of time.

2. The method of claim 1, wherein determining the sensor data condition comprises determining that the portion of the face of the user is currently occluded.

3. The method of claim 1, wherein determining the sensor data condition comprises predicting that the portion of the face of the user is about to become occluded.

4. The method of claim 1, wherein determining the sensor data condition comprises determining that the portion of the face of the user is currently or is about to be occluded by a hand of the user.

5. The method of claim 1, wherein the portion of the face of the user comprises a mouth region of the user.

6. The method of claim 1, wherein the prior user data comprises user data representing an appearance of the portion of the face of the user captured during a time period immediately before occlusion occurs.

7. The method of claim 1, wherein the prior user data comprises user data representing an appearance of the portion of the face of the user captured during an enrollment period during which images of the face of the user are captured in a plurality of facial configurations.

8. The method of claim 1, wherein the user representation is generated during a live capture session during which sensor data from a period without occlusion is maintained for use during periods of occlusion.

9. The method of claim 1, wherein generating the user representation corresponding to the portion of the face of the user being occluded in the sensor data comprises, generating the user representation to preserve the immediately prior facial expression of the user during the period of time.

10. The method of claim 9, wherein other portions of the face of the user are represented based on live sensor data corresponding to the live appearance of the other portions of the face of the user during a period of time.

11. The method of claim 10, wherein a visual treatment is provided between the portion of the face of the user and the other portions of the face of the user.

12. The method of claim 1, wherein generating the user representation corresponding to the portion of the face of the user being occluded in the sensor data during the period of time comprises generating a gradual change for the portion of the face of the user being occluded in the sensor data.

13. The method of claim 12, wherein the gradual change morphs a first appearance of the portion of the face corresponding to a first expression occurring immediately prior to the occlusion to a second appearance of the portion of the face corresponding to a second expression different than the first expression.

14. The method of claim 1 further comprising:
determining a second sensor data condition corresponding to the portion of the face of the user no longer being occluded in the sensor data;
based on determining the second sensor data condition, determining to utilize live user data to generate at least the portion of the user representation corresponding to the portion of the face of the user no longer being occluded in the sensor data during a second period of time; and
generating the user representation corresponding to the portion of the face of the user no longer being occluded in the sensor data during the second period of time.

15. The method of claim 14, wherein generating the user representation corresponding to the portion of the face of the user no longer being occluded in the sensor data during the second period of time comprises generating a gradual change for the portion of the face of the user.

16. The method of claim 15, wherein the gradual change morphs a first appearance of the portion of the face corresponding to a first expression to a second appearance of the portion of the face corresponding to a second expression different than the first expression.

17. The method of claim 1 further comprising applying a visual treatment while a user representation is based on non-live user data indicating that the portion of the face of the user represented in the user representation may not depict an actual current facial expression of the user.

18. The method of claim 17, wherein an attribute of the visual treatment is based on an amount of the face that is occluded.

19. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
determining a sensor data condition corresponding to a portion of a face of a user being occluded in sensor data;
based on determining the sensor data condition, determining to utilize prior user data to generate at least a portion of a user representation corresponding to the portion of the face of the user being occluded in the sensor data during a period of time; and
generating the user representation corresponding to the portion of the face of the user being occluded in the sensor data during the period of time.

20. A non-transitory computer-readable storage medium, storing program instructions executable on a device to perform operations comprising:
determining a sensor data condition corresponding to a portion of a face of a user being occluded in sensor data;
based on determining the sensor data condition, determining to utilize prior user data to generate at least a portion of a user representation corresponding to the portion of the face of the user being occluded in the sensor data during a period of time; and
generating the user representation corresponding to the portion of the face of the user being occluded in the sensor data during the period of time.
